(19) United States
(12) Patent Application Publication
(10) Pub. No.: US 2022/0217273 A1
(43) Pub. Date: Jul. 7, 2022

(54) SPHERICAL CAMERA WITH MAGNETIC BASE

(71) Applicant: Zorachka, Inc., Ladera Ranch, CA (US)

(72) Inventors: Ruslan Vinahradau, Minsk (BY); Aliaksandr Harbachou, Minsk (BY); Aliaksandr Karnavushenka, Minsk (BY); Siarhei Haiduchonak, Minsk (BY); Aliaksandr Ivanou, Kopische (BY); Pavel Guchok, Minsk (BY); Aliaksei Adamovich, Volkovysk (BY)

(21) Appl. No.: 17/142,303

(22) Filed: Jan. 6, 2021

(51) Int. Cl. H04N 5/232; G03B 17/56; G08B 15/00

(52) U.S. Cl. CPC H04N 5/23238; G03B 17/561; G08B 15/001; G03B 17/563

(57) ABSTRACT

A video recording device (video camera), a stand (magnetic support) and a wall/ceiling attachment is disclosed. The video recorder consists of a video camera with a high-quality sensor and a lens with a wide field of view. It is placed in a spherical housing with a semi-transparent stealth segment window. The video recording device is fixed on the stand using a magnetic holder, which allows one to orient and fix the video camera within 360 degrees around the vertical axis and within 0-180 degrees around the horizontal axis. The wall/ceiling mounting bracket (attachment) makes it possible to place the video camera on vertical (inner wall of the room, walls of cabinets, furniture, etc.), horizontal (ceiling of the room) and inclined surfaces of any configuration. The device is capable of video recording in insufficient and reduced illumination conditions of a room.

### CROSS-REFERENCE TO RELATED APPLICATIONS

This non-provisional patent application claims priority to U.S. Provisional Patent Application 62/959,094 “Integrated Advanced Multi-User Smart Home Video Surveillance System” Vladimir Perekladov, Ruslan Vinahradau, Uladislau Bialiauski, Siarhei Haiduchonak, Aliaksandr Karnavushenka, Alexey Trufanov, Aliaksandr Ivanou, and Aliaksandr Harbachou, filed Jan. 9, 2020.

This non-provisional patent application is further related to the following US patent applications:
1. U.S. Design patent application Ser. No. ______, “Electronic Device—Security Camera” filed on ______.
2. U.S. Non-Provisional patent application Ser. No. ______, “Digital media data management system comprising software-defined data storage and an adaptive bitrate media streaming protocol”, filed on ______.
3. U.S. Non-Provisional patent application Ser. No. ______, “Digital media data management system comprising software-defined data storage and an adaptive bitrate media streaming protocol”, filed on ______.
4. U.S. Non-Provisional patent application ______, “Single-screen timeline-based interactive graphical user interface design concept and the set of user experience rules for consuming multimedia data on a handheld device touchscreen”, filed on ______;

all of which are hereby incorporated by reference.

### FEDERAL RESEARCH STATEMENT

None

### FIELD OF THE INVENTION

The present invention is directed generally to video monitoring/surveillance systems with wireless connection/control of the device with magnetic fixation of the camera to a stand. The invention is intended to improve the safety of residential and commercial buildings, as well as adjacent territories. In addition, the invention could be used as an integral part of an integrated “smart home” system.

### BACKGROUND OF THE INVENTION

Video monitoring/surveillance systems that connect to home networks are increasing in popularity. For aesthetic purposes it would be desirable to implement a video recorder of a specific shape, in particular a spherical shape with a camera lens hidden behind a protective glass.

In addition, it would be desirable to have the ability to mount the video recorder on all types of surfaces with the ability to change the position and location of the camera quickly. For example, the camera could be affixed magnetically to appropriate structures.

In order to create a compact camera with the ability to transfer data using Wi-Fi and a cellular network, one of the modules can be placed in the camera's power supply.

### SUMMARY OF THE INVENTION

The present invention is an apparatus comprising a video recording device (video camera), a stand (magnetic support) and a wall/ceiling attachment. The video recorder consists of a video camera with a high-quality sensor and a lens with a wide field of view. It is placed in a spherical housing with a semi-transparent stealth segment window. The video recording device is fixed on the stand using a magnetic holder, which allows you to orient and fix the video camera within 360 degrees around the vertical axis and within 0-180 degrees around the horizontal axis. The wall/ceiling mounting bracket (attachment) makes it possible to place the video camera on vertical (inner wall of the room, walls of cabinets, furniture, etc.), horizontal (ceiling of the room) and inclined surfaces of any configuration. The device is capable of video recording in insufficient and reduced illumination conditions of a room.

There are several unique features of the instant invention which are summarized as follows:
the method of magnetization of the stand;
a universal stand that is suitable for wall and shelf mounting using a Tilt sensor (accelerometer) to rotate the picture;
the method of placing the lens and illumination behind the stealth glass;
the features of the implementation of a sound-emitting and sound-recording system;
a method for implementing the volume of speakers;
the location of microphones for beam-analytic purposes;
the internal layout of nodes for LTE and WiFi camera versions;
the method of printed circuit boards mounting;
internal arrangement of Wi-Fi antennae;
implementation features of a transport channel combined with a power supply system for the Wi-Fi with LTE version

### DESCRIPTION OF THE PRIOR ART

There are numerous examples of security cameras using infrared in low illumination areas and transmitting digital pictures wirelessly to a remote viewer. For example, U.S. Pat. No. 10,877,266 Digital Camera With Wireless Image Transfer to Solomon disclosed a system for the automated correction optical and digital aberrations in a digital imaging system. In addition, U.S. Pat. No. 10,845,166 Surveillance Device to Campbell discloses a surveillance system comprising a housing dimensioned to enclose a plurality of cameras and one or more viewing windows to allow light to pass through the housing and which is in wireless communication with one or more external devices. Also, U.S. Pat. No. 10,839,659 System for Video Monitoring with Improved Image Quality to Van Cleave discloses optimum use of infrared light to improve video camera image quality. However, none of the prior art presents the combined desirable attributes of the present system with regard to a variety of camera mounting options, image rectification, stealthy and inconspicuous appearance, layout of microphones for beam analytics, wide area of capture, internal layout of WiFi antennae and other distinguishing attributes.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is a schematic view of the present invention of a video recorder 50 with a stand 200 positioned on a horizontal surface 210.

FIG. 2 shows a schematic top view of the present invention of a video recorder 50 with a stand 200 that is placed on a horizontal surface 210.

FIG. 3 shows an exploded view of the video recorder 50.

FIG. 4 is a front view of the video camera module 100.

FIG. 5 is a side view of the video camera module and a side insert 13.

FIG. 6 shows an example of the construction of the video recorder 50 with the tinted glass with a stealth effect 12 and the inner insert 13 removed.

FIG. 7 shows a diagram of the path of the beams of the infrared LEDs 25a-25h total illumination in the vertical plane of the vertical field of view 305 of the video recorder 50.

FIG. 8 shows a diagram of the path of the beams of the illumination system infrared LEDs 25a-25h in the horizontal plane of the horizontal field of view 315 of the video recorder 50.

FIG. 9 shows an axonometric projection of a schematic representation of the video recorder field of view 320 and the video recorder illumination front 270 in low light conditions.

FIG. 10 is a top view of the video recorder 50 installed in a magnetic support.

FIG. 11 is an enlarged view of the lower hemisphere complex 150.

FIG. 12 shows a processing, storage and/or data transmission unit 160.

FIG. 13 is an enlarged view of a magnetic support 200.

FIG. 14 shows installation of the magnetic support 200 on a horizontal surface 210.

FIG. 15 shows a side view of the magnetic support 200 mounted on a horizontal surface 210 with an optional video recorder 50 that is placed in the magnetic support 200.

FIG. 16 shows a wall bracket 54 on a vertical surface 220.

FIG. 17 shows attachment of a wall bracket 54, magnetic support 200 and optional video recorder 50 to a vertical wall 220.

FIG. 18 shows attachment of a wall bracket 54, magnetic support 200 and optional video recorder 50 to a vertical wall 220.

FIG. 19 shows attachment of a wall bracket 54, magnetic support 200 and optional video recorder 50 to an inclined surface.

FIG. 20 shows attachment of a wall bracket 54, magnetic support 200 and optional video recorder 50 to an inclined surface.

FIG. 21 shows an inverted video recorder 50.

FIG. 22 shows the connection of the power cable 81 to the matching camera cable connector 80 of the video recorder 50.

FIG. 23 shows the general structure of the WiFi-LTE-PoE power supply.

FIG. 24 shows the general structure of the WiFi-LTE-USBC power supply.

FIG. 25 is a schematic of the AC adapter structure PoE variation.

FIG. 26 is a schematic of the AC adapter structure USB PD variation.

FIG. 27 shows the LTE transceiver structure.

FIG. 28 is a diagram illustrating the WiFi module with the PoE Power extractor in the HOMAM WiFi-LTE-PoE.

FIG. 29 is a diagram illustrating the WiFi module with the USB PD extractor in the HOMAM WiFi-LTE-USBC.

FIG. 30 illustrates cable specifications CAB.69.003.

FIG. 31 illustrates cable specifications CAB.69.004.

### DETAILED DESCRIPTION OF THE INVENTION

### General Description

This disclosure describes several variations of the instant video recording device. For ease in understanding, this disclosure focuses on the Wi-Fi variant, although it is understood that other variations are possible.

The present invention provides the technical ability to conduct video surveillance with various modes of video recording quality (from low to high), with a wide area frame capture angle. The video camera is equipped with a high-quality sensor. It has the following abilities: to wirelessly transmit data, a wireless control, the ability to play-back high-quality sound in stereo, two-channel sound recording, high-quality video and audio recording in the dark and/or in low interior light. The innovative magnetic fixation method inherent in the video recorder holder allows one to conveniently and quickly position the video camera at the desired angle to the observed object, and the wide angle of the lens field of view eliminates the need to install more than one device in the room. The presence of a wall/ceiling mounting bracket makes it possible to use this invention in any room with a different configuration of the inner perimeter. This invention can be networked and operated as part of an integrated “smart home” system.

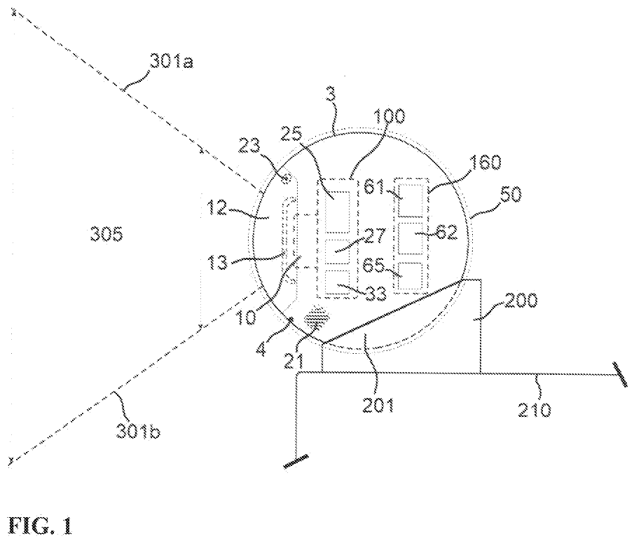

FIG. 1 shows a schematic view of the present invention of a video recorder 50 with a stand 200 positioned on a horizontal surface 210. In this configuration, the surface 210 is the horizontal surface of a table. Also, any horizontal surface of the room can act as a plane 210 (for example, a shelf, the top wall of a refrigerator or cabinet, etc). The present invention consists of a video recorder 50 with a spherical camera body 3, in which a video image capture unit (video camera module 100) can be placed, a processing, storage and/or data transmission unit 160, an internal insert 13 tinted glass with a stealth effect 12. The housing can contain a microphone opening 23 for recording sound signals, a speaker opening 21 for playing sound signals, an indication window 4 for working state of the video recorder 50. Through the microphone opening 23, any audio signals occurring in the room can be recorded and/or transmitted. The recorded audio signals can be recorded on the data storage device 62, transferred to an external device via the data transfer device 65 and/or played back through the speaker openings 21 of the video recorder 50. Playback may be necessary when using the device 50 video recordings in the intercom mode.

The spherical body 3 can be of single or multipart construction made of metallic and/or non-metallic materials. The body 3 may contain metal parts with magnetic properties, which are necessary for the implementation of the magnetic fixation mechanism of the magnetic support 200. The contact area of the case and the magnetic support is part of the spherical contact surface 201. The magnets necessary for the implementation of the magnetic fixation mechanism of the device video recordings 50 are located in the stand 200. The video camera module 100 may contain printed circuit boards, a camera lens 10, infrared LEDs 25, a three-axis accelerometer 27, an audio signal processing unit 33, and other devices. The three-axis accelerometer 27 makes it possible to record a video signal in cases where the video recorder is installed upside down and/or fixed to the ceiling and/or vertical wall with the device turned around the horizontal axis. In this case, the registered image is transformed by the software into the original (correct) orientation automatically. The infrared LEDs 25 allows recording video frames in low and insufficient illumination of the observed object at night and/or in low light indoors.

The processing, storage and/or data transmission unit 160 may contain printed circuit boards, a video signal processor 61, a data storage device 62, a data transmission device and/or communication with an external device 65. The video signal processor 61 allows registration of a video stream consisting of video frames captured by the camera module 100. In addition, the video processor 61 can process video data by encoding and/or decoding. Various operations with data (for example, permanently and/or temporarily storing, recording, copying, etc.) can be performed using a data storage device 62. In this case, data is understood as any information which is in a digital form. For example, it can be video files, camera image frames, audio files, etc. A data transfer device 65 permits external connection to a video recorder 50 from an external user device (smartphone, computer, tablet, laptop, etc.) using wireless (WiFi, Bluetooth, etc.) or wired (USB cable) connection technologies. Through the implemented connection, the user can send commands to the video recorder 50, perform operations with data (recording, deleting, transferring, copying, etc.), turning on/off the power to the device. Also, the presence of a data transfer device 65 allows this video recorder 50 to be used as part of an integrated “smart home” system, to combine devices into network chains, and to use them in data exchange within the framework of the created observation and communication system. Some nodes, blocks and devices are not shown.

A special and unique feature of the present invention is the presence of a tinted glass with stealth effect 12 which renders the system much less conspicuous to a potential intruder. Experience has shown that potential intruders learn how to recognize a security camera by its infrared lights and can render it useless by spray painting or covering the lens somehow. The stealthy, inconspicuous nature of the present device leads to greater security. Tinting gives the effect of non-visibility and secrecy, due to the fact that the camera lens 10, infrared LEDs 25 and other devices and units of this invention become invisible to an external observer. With this design feature, the video recorder 50 appears to be part of the interior without the discomfort of the surveillance device being present. The infrared LEDs 25 are also hidden behind a tinted glass with a stealth effect 12 and an internal insert 13, which makes the infrared diodes hidden, but at the same time the device remains effective in the night video shooting mode. This is due to the tinted glass with a stealth effect 12 and the internal insert 13 are transparent in the infa-red spectral range (800-1000 nm). This stealth effect provides an advantage when attempting a robbery—the benign appearance of a video camera and its special design makes it invisible to robbers.

The number and/or arrangement of assemblies and devices in this invention may vary depending on the application and design of the embodiment of the invention.

FIG. 1 also depicts the vertical field of view 305 of the video camera as bounded by lines 301a-301b. Images in the vertical plane can be captured within area 305. In FIG. 1, the horizontal axis of the video camera is parallel to the horizontal plane of horizontal surface 210. The video recorder 50 can be rotated on the magnetic support 200 to select different areas for recording. The magnetic support 200 has the ability to be mounted on various surfaces (horizontal, vertical, inclined, metallic and non-metallic), which significantly expands the scope of the embodiment of the present invention.

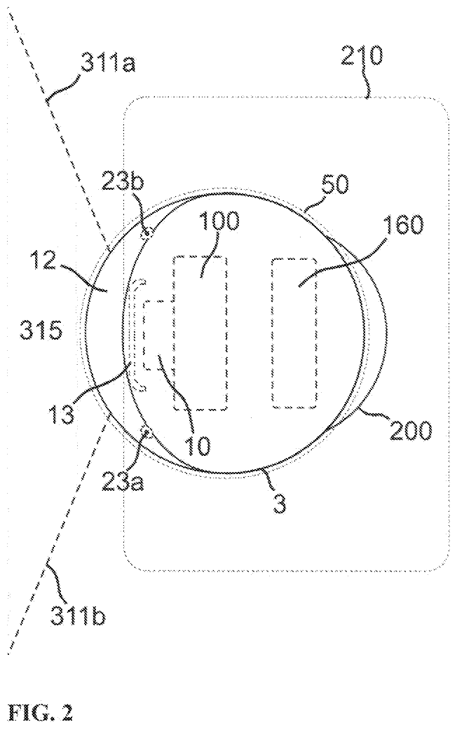

FIG. 2 shows a schematic top view of the present invention of the video recorder 50 and stand 200 that is placed on a horizontal surface 210. The view which is shown depicts the horizontal field of view 315 of a video recorder 50, bounded by lines 311a-311b. The horizontal image capture can occur within a given horizontal field of view 315.

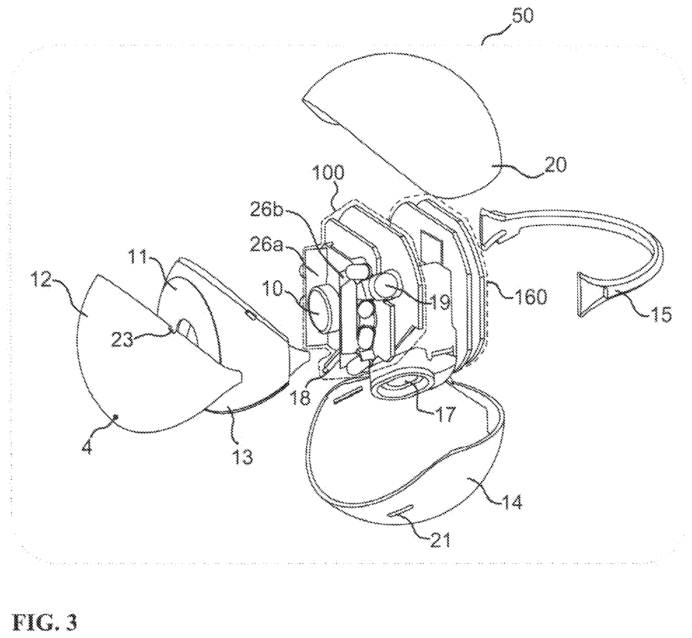

FIG. 3 shows an exploded view of the video recorder 50. This view shows the various blocks and devices of the present invention. In particular, the given exploded view of the video recorder 50 shows the lower hemisphere of the housing 14 with the speaker opening 21 located so as to disseminate sound from the audio loudspeaker 17, the upper hemisphere of the housing 20, and the semicircular insert 15. The semicircular insert 15 is an exterior design element and may function as a holder for the tinted glass 12, the video camera module 100 and processing, storage and/or data transmission unit 160. This view shows the video camera module 100 with camera lens 10, Wi-Fi antenna 26a-26b, light guide 18 of the video camera operating status indicator. Also shown is a microphone 19, a lens hood 11, an internal insert 13. Internal insert (13) is non-transparent in visible light and transparent in near infra-red light. As a result it hides camera internals from the human observer and does not block light emitted by infra-red LEDs 25 which are installed behind. This view shows the protective tinted glass with associated stealth effect 12, in which a microphone opening 23 can be located, an indication window 4 of the operating state of a video recorder 50. This view also shows the processing, storage and/or data transmission unit 160. The semicircular insert 15 can be made of a material similar to the material of the tinted glass with a stealth effect 12. The semicircular insert 15 can act as a fixture of the processing, storage and/or data transmission unit 160. The device may contain other components which are not shown in this FIG. 3. The number, type and/or arrangement of any of the elements and devices of the present invention may vary depending on the design and application.

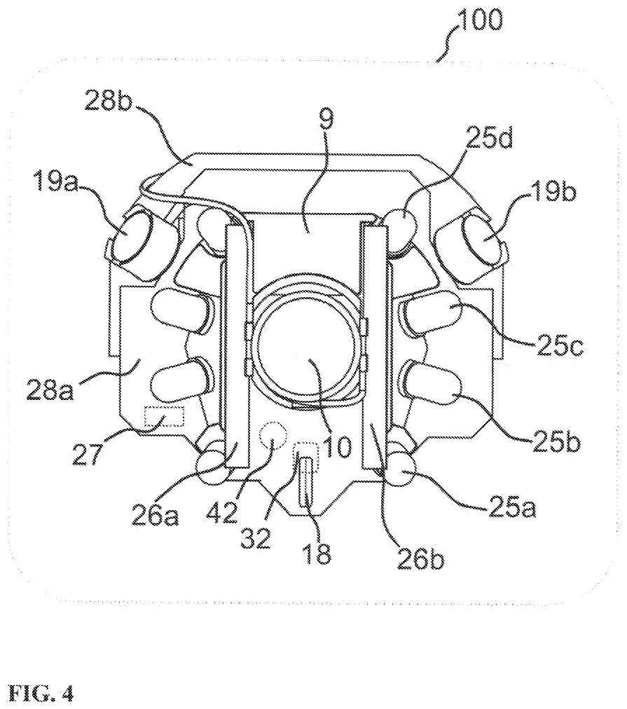

FIG. 4 is a front view of the video camera module 100. This view shows one embodiment of a video camera module 100. The module may contain a video camera lens 10, an image sensor, which is a part of video camera module 100 and located behind the camera lens 10, a set of printed circuit boards 28a-28b with devices and elements installed on them. The shape and/or the number of boards 28a-28b, the location and/or the shape/type of the camera lens 10 and the image sensor may vary depending on the design and/or application of the present invention. On the board 28a, there can be a backlight holder 9, a three-axis accelerometer 27, connectors for connecting microphones 19a-19b, an LED indicator 32 of the operating status of the video camera.

The backlight holder 9 can accommodate the Wi-Fi antennae 26a-26b of a wireless data transfer device 65, a light guide 18 for the video camera status indicator, IR LEDs 25a-25d for image capture in insufficient illumination. The shape of the backlight holder 9 can be different depending on the type and/or the number of devices and elements which are located on it. Microphones 19a-19b enable two-channel (stereo) recording of incoming audio signals. An ambient light sensor 42 can switch the video recording mode from day to night. In the night mode, the objects of observation and video recording can be illuminated with infrared LEDs 25a-25d. The three-axis accelerometer 27 makes it possible to register a video signal in cases where the video recorder 50 is installed upside down and/or fixed to the ceiling and/or a vertical wall with the device turned around the horizontal axis. With this type of arrangement, a software flip of the recorded video signal occurs to its original position, and the input channels of the microphones 19a-19b (left-right) are swapped.

The light guide 18 of the operating state indicator of the video camera is intended to transmit the current (actual) color of the LED indicator 32 to the indicator window 4 (FIG. 3) of the tinted glass with a stealth effect 12 (FIG. 3). As a result, the user, being at some distance without an external device connected wirelessly to the video recorder 50, is able to understand what function the present invention currently performs. For example, when the video recording mode is on, the indicator window 4 of the stealth glass 12 may be red. The shape and/or number and/or arrangement of the devices shown may vary depending on the design or application of the invention. Some devices and blocks are not shown. LED indicator of the operating status of the camera 32, infrared LEDs 25a-25d and some other elements and devices installed on the printed circuit board 28a are shown in FIG. 4.

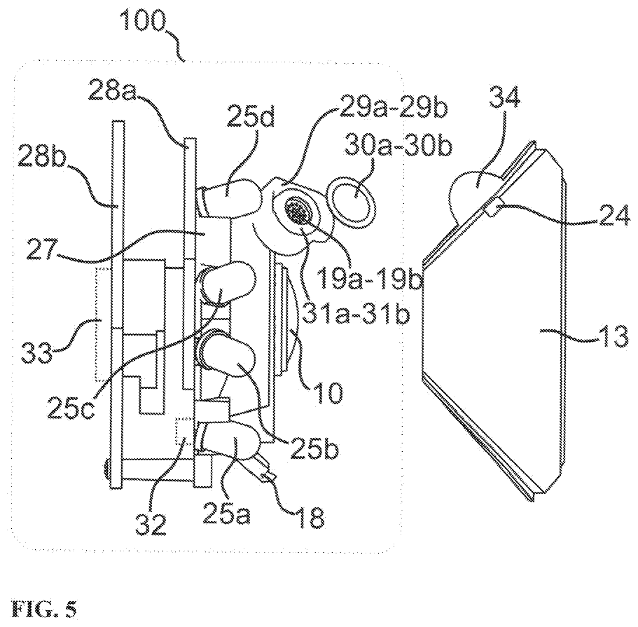

FIG. 5 shows a side view of a video camera module 100 and an internal insert 13 of one embodiment of the present invention.

In the illustrated example, the video camera module 100 contains a set of printed circuit boards 28a-28b. On circuit board 28b there may be a camera lens 10 with an image sensor and audio signal processing unit 33. Some devices may not be shown on boards 28a-28b of the given view. The LED of the status indicator 32 can be configured for different modes of operation and performance of the device functionality. For example, when recording video and saving information to the built-in storage medium, LED 32 may light up red. The audio signal processing unit 33 can be configured to transmit (broadcast) audio signals from an external device and/or other connected devices via a wireless link (for example, via Wi-Fi antennae 26). Microphones 19a-19b are shown in FIG. 4 and FIG. 5. In the current embodiment of the invention, the number of microphones is equal to two, which makes it possible to produce two-channel audio recording of audio signals (stereo). When the camera is turned 180 degrees around its horizontal axis, the location of the input channels is automatically reversed by the command from the three-axis gyroscope 27. In this view, the microphones 19a-19b are placed in the microphone housings 29a-29b and are fixed with fixation rings 31a-31b. The microphone housing 29 can be located in the protrusion 34 of the inner insert 13. The insert may have microphone holes 24 which serve as an opening for sound waves. Dimensions, location, number and/or shape of the parts and devices shown may vary depending on the design and application of this invention.

Infrared LED Arrangement

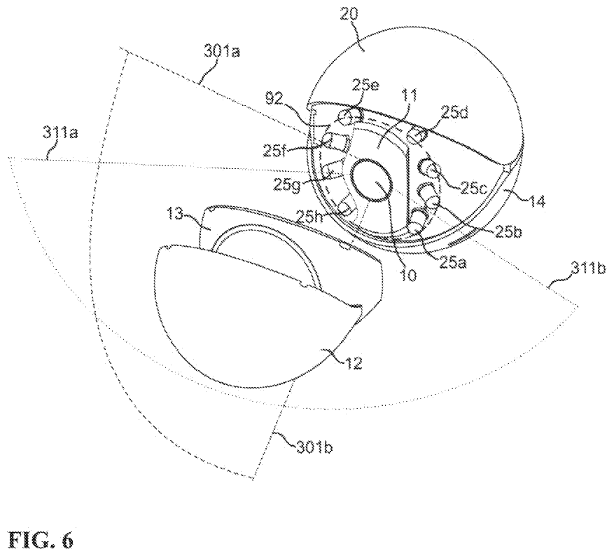

FIG. 6 shows an example of the construction of the video recorder 50 including the tinted glass with a stealth effect 12 and furthermore with the inner insert 13 removed. The view shows the location of the lens hood 11 of the video camera relative to the camera lens 10. This view shows the location of the infrared LEDs 25a-25h in the construction of this example. In this embodiment, the infrared LEDs 25a-25h are used as sources of light in the night mode. The infrared LEDs 25a-25h are arranged so that their emitting areas form an elliptical curve 92 in space. This special arrangement makes it possible, in case of poor video recording conditions (for example, at night and/or in rooms with insufficient illumination), to produce illumination of the registered objects falling into the field of view of the camera lens. The constituent parts that form the full wide field of view of the lens may be a vertical video frame capture area bounded in the shown form by lines 301a-301b and a horizontal video frame capture area limited by lines 311a-311b. The unique method of placing infrared LEDs 25a-25h behind the inner insert 13 and protective tinted glass with stealth effect 12 makes them invisible to the external observer, which is attractive in terms of design and appearance of the product. In this case, the inner insert 13 and the protective tinted glass 12 can be made of various non-metallic materials that have a dimming effect (light absorption) in the visible spectral range and simultaneous light transmission in the 800-1000 nm spectral range. Due to the special arrangement along the curve 92, there is no screening of the light flux from the emitting areas of IR LEDs 25a-25h by the opaque parts of the video recorder 50. Screening means that the entire scene located in the camera's field of view is illuminated by the camera's infra-red LED's. The lens hood makes a non-transparent screen, preventing light from the infra-red LED's from reflecting from the central part of the tinted glass 12 and pass to the camera lens. In this embodiment, such opaque parts are the lens hood 11, the upper hemisphere of the housing 20 and the lower hemisphere of the housing 14. This makes it possible to illuminate all objects that completely fall into the field of view of the camera lens. Due to the presence of the backlight system 25 (FIG. 1), in conditions of insufficient illumination, objects falling into the field of view of the video surveillance device 50 become clearly visible and clearly distinguishable, which may be useful in dim light and no light.

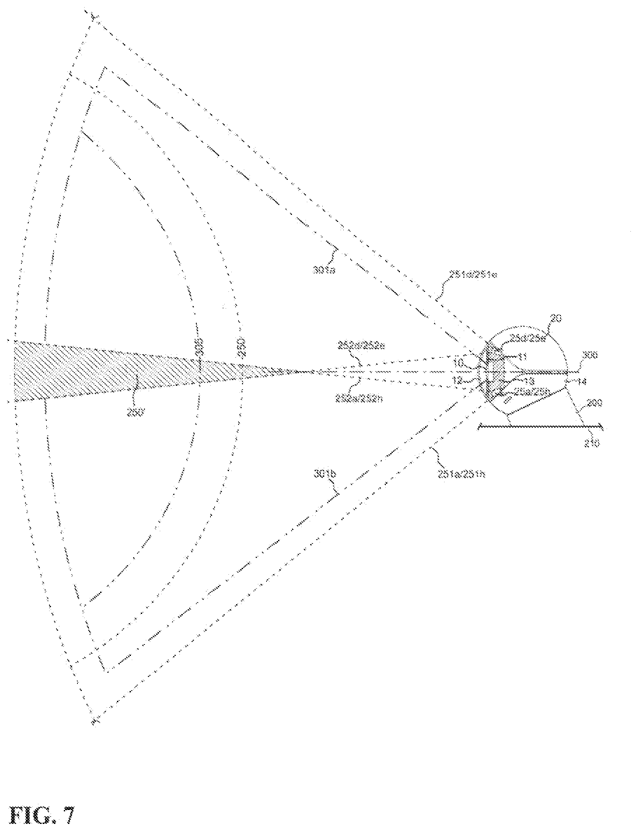

FIG. 7 shows a diagram of the path of the beams of the infrared LEDs 25a-25h resulting in total infrared illumination in the vertical plane of the vertical field of view 305 of the video recorder 50. The vertical field of view 305 of the video camera is limited by the lines 301a-301b. This view demonstrates a video camera lens 10, a video camera lens hood 11, a tinted glass with a stealth effect 12 and an inner insert 13. This view shows the upper hemisphere 20 and the lower hemisphere of the housing 14. The video recording device 50 is located in a magnetic support 200 on a horizontal surface 210. The horizontal axis 300 is schematically represented as the optical axis of the infrared illumination system 25. It can be seen from the given ray path diagram that the vertical illumination front 250 is formed by the extreme infrared LEDs 25a/25h and/or 25d/25e. The entire vertical illumination front 250 is limited by the divergence angles of each of the infrared LEDs 25a/25h and/or 25d/25e and their arrangement in the structure of the present invention. The angles of divergence of the LEDs 25a/25h and 25d/25e in the shown diagram are limited by lines 251a/251h and/or 251d/251e. The diagram shows that the illumination area of the upper and lower rows of infrared LEDs 25a/25h and/or 25d/25e has an overlap area 250 in the vertical plane of the beam path. The presence of the specified overlap area 250 guarantees the exclusion of dead zones in the vertical field of view 305 of the video recorder, in which objects may appear in case of insufficient illumination of the room scene. As can be seen from FIG. 6-FIG. 7, a special spatial arrangement of infrared LEDs 25a/25h and/or 25d/25e (along the curve 92) can form the vertical illumination front 250 for video recording of objects in the vertical field of view 305 of the video recorder 50 with guaranteed illumination overlap.

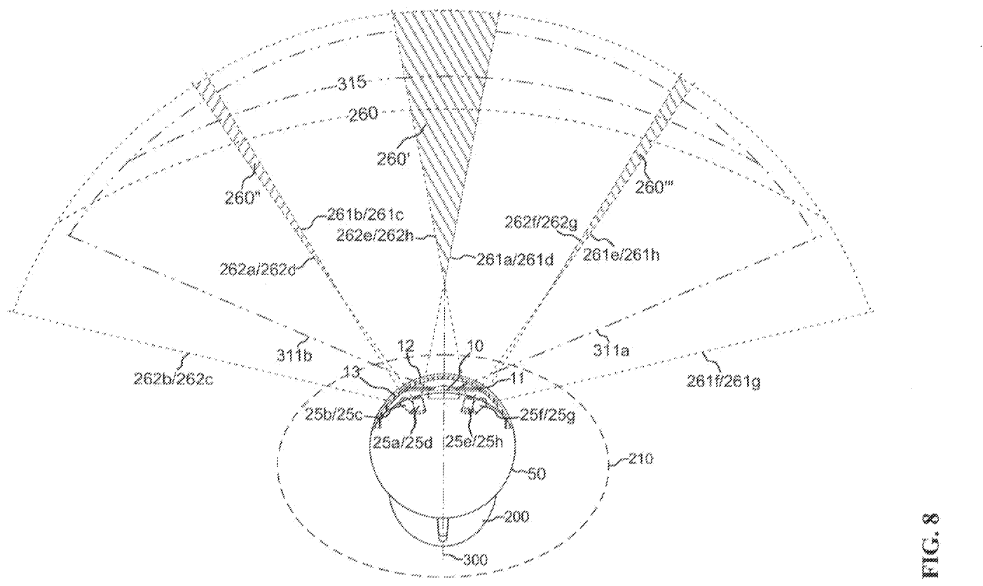

FIG. 8 shows a top view diagram of the path of the beams of the illumination system infrared LEDs 25a-25h in the horizontal plane of the horizontal field of view 315. The horizontal field of view 315 is limited by lines 311a-311b. This view shows a video camera lens 10, a video camera lens hood 11, a tinted glass with a stealth effect 12, and an inner insert 13. This view shows the upper hemisphere of the housing 20. The video recorder 50 is located in a magnetic support 200 on a horizontal surface 210. The horizontal axis 300 is schematically shown as the optical axis of the infrared LEDs 25 illumination system. From the given beam path, it is seen that the horizontal illumination front 260 is formed by infrared LEDs 25a-25h. The entire horizontal illumination front 260 is limited by the divergence angles of each of the infrared LEDs 25a-25h and their arrangement in the structure. The divergence angles of the LEDs 25a-25h in the shown diagram are limited by horizontal infrared illumination boundary lines 261a-261h and 262a-262h. The diagram shows that the illumination areas of the infrared LEDs 25a-25h have horizontal illumination front overlap areas 260′, 260″, 260′ in the horizontal plane of the beam path. The presence of the specified horizontal illumination front overlap areas 260′, 260″, 260′″ guarantees the elimination of dead zones in the horizontal field of view 315 which may appear due to insufficient illumination. As can be seen from FIG. 6-FIG. 8, the special spatial arrangement of infrared LEDs 25a-25h (along curve 92) can form the horizontal illumination front 260 in the horizontal field of view 315 of the video recorder 50 with guaranteed overlap of the video frame capture area.

In view of the particular design in the spherical shape of the housing 3 of the video recorder 50, the inner insert 13 and the tinted glass with a stealth effect 12 can be made in the form of segments of a sphere. This can have a negative impact on the path of rays from infrared LEDs 25a-25h to the illuminated object according to the laws of geometric optics. For example, to introduce parasitic illumination of the camera lens 10 of the video camera due to reflection from the surfaces of the tinted glass with a stealth effect 12 and/or the internal insert 13. The arrangement in the design of this invention, the number of infrared LEDs and/or the angle of divergence of each of the infrared LEDs 25a-25h are selected in such a way that the luminous flux of each of the infrared light sources is not shielded and/or internally re-reflected with light from the camera lens 10 of the video camera when the optical path passes through the inner insert 13 and the tinted glass with a stealth effect 12 to the illuminated object. This design solution is a competitive advantage and distinguishes the presented invention from its counterparts.

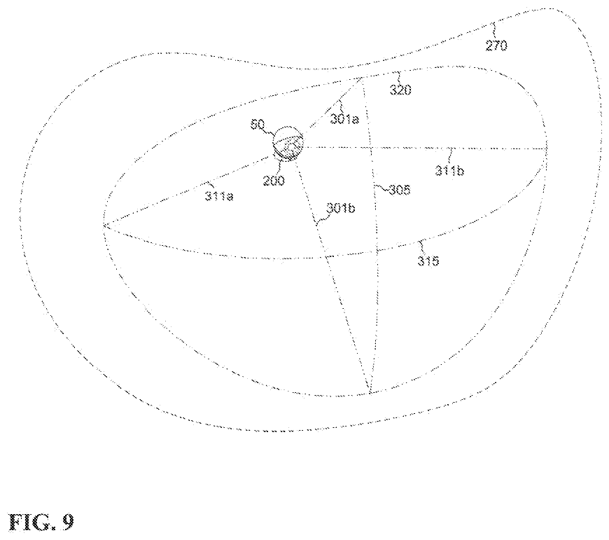

FIG. 9 shows an axonometric projection of a schematic representation of the video recorder field of view 320 and the video recorder illumination front 270 in low light conditions (for example, at night and/or in insufficient illumination). In the above diagram, it can be seen that the total video recorder field of view 320 is formed by the horizontal 315 and vertical 305 regions of the field of view and a set of components formed within the intersection of these regions. The full video recorder illumination front 270 in conditions of insufficient illumination is formed by sources of infrared radiation (in this embodiment of the invention, infrared LEDs 25a-25h), their constructive (mutual) arrangement and/or angles of divergence of each of the sources and/or the path of the rays in space. In this embodiment of the present invention, as can be seen in FIG. 7-FIG. 9, the video recorder illumination front 270 completely covers the full video recorder field of view 320, which makes it possible to perform video recording in conditions of insufficient illumination and/or at night of any objects in the field of view video recorder 50.

### Wi-Fi Antennae Arrangement

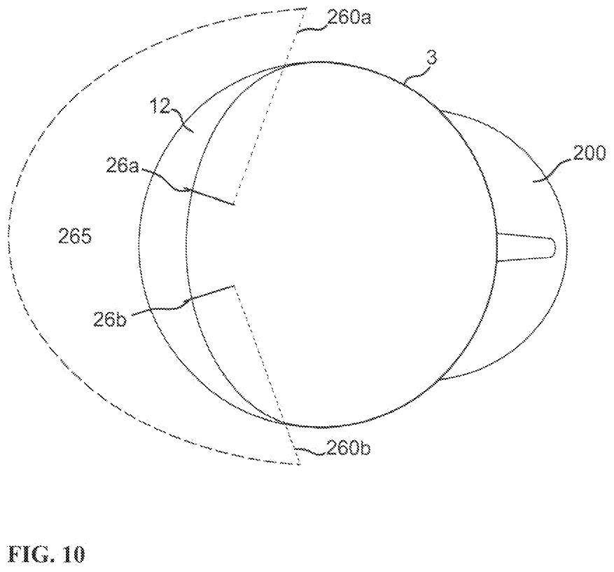

For a better understanding of the principal implementation of the operation of the Wi-Fi antennae 26a-26b of the present invention in a metal (e.g., aluminum or similar metal) spherical camera body 3, a top view in FIG. 10 of a video recorder 50 installed in a magnetic support 200 is shown.

The view shows the locations of two Wi-Fi antennae 26a-26b. From the given example, it can be seen that the position of the Wi-Fi antennae 26a-26b in the spherical camera body 3 of the video recorder 50 and their relative position forms the zone of reception and/or transmission of the Wi-Fi signal 265, limited by lines 260a-260b. The designated area is located in the transparency zone of the Wi-Fi signal, which freely penetrates without interference through the tinted glass with a stealth effect 12 and then the inner insert 13. Due to the spherical shape of the glass 12 and the inner insert 13, as well as the non-metallic nature of the material, there is no screening and/or attenuation of the transmitted and/or the received Wi-Fi signal in different directions of its propagation. This innovative design feature is unique compared to similar devices.

### Lower Hemisphere Arrangement

FIG. 11 is an enlarged view of the lower hemisphere complex 150 of one embodiment of the present invention. This view shows the lower hemisphere of the housing 14, the mounting rack 38, the speaker bracket 70, the audio loudspeakers 17a-17b, and the processing, storage and/or data transmission unit 160. The processing, storage and/or data transmission unit 160 may contain a set of printed circuit boards 32a-32b. The board 32b can accommodate a data transfer device 65 with a video recorder 50. The mounting rack 38 can be configured with fixed grooves 41 for a set of printed circuit boards 32a-32b, preventing their movement during transportation and/or operation. The illustrated lower hemisphere of the housing 14 may have speaker openings 21a-21b for the output of audio signals from the speakers 17a-17b. To prevent dust and dirt from entering the device, protective nets 36a-36b can be used, which can be placed in the understates 37a-37b. In this version of the video recorder, special sealing rings 35a-35b are displayed, which are auxiliary elements of the implementation of the surround sound mechanism. Speakers 17a-17b can be uniquely mounted on the speaker holders 71a-71b.

In this invention, in order to obtain high quality surround sound of the speakers 17a-17b, a special bracket was invented, for which there are volumetric cavities 72a-72b that are located behind the speakers. The shape and volume of the cavities 72a-72b are designed in such a way that when the speakers are placed in the holders 71a-71b, the cavities behind the speakers are acoustically isolated and work as a sealed acoustic suspension chambers for the speakers. The shape, arrangement and/or number of speaker openings 21, speakers 17a-17b, protective nets 36a-36b, and sealing rings 35a-35b may vary depending on the configuration and application of the present invention.

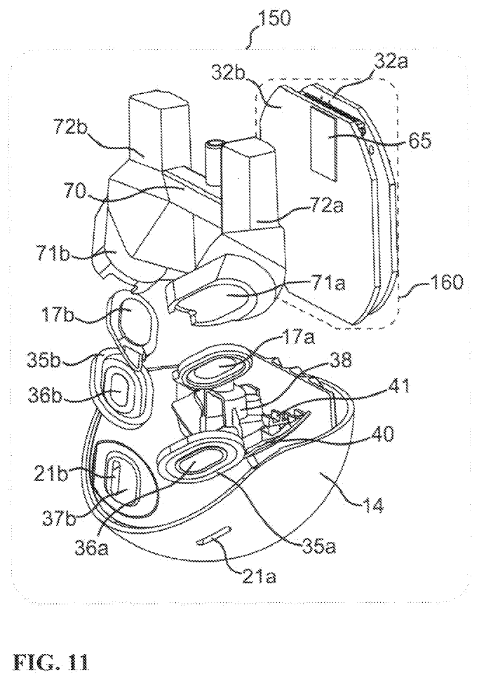

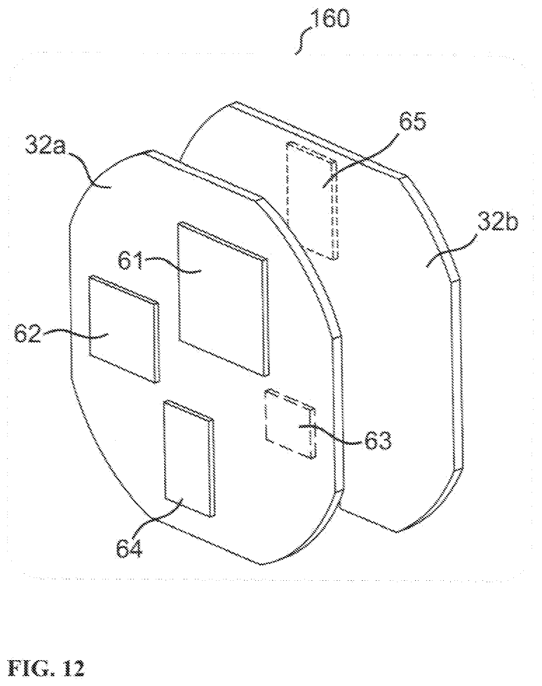

FIG. 12 shows a processing, storage and/or data transmission unit 160 of one embodiment of the present invention. As shown, block 160 may include circuit boards 32a-32b. Board 32a may house a video signal processor 61, a data storage device 62, a power conversion/supply module 63, and/or a memory module. Some other devices may not be shown on boards 32a-32b that are demonstrated. The video signal processor 61 can generate a video stream consisting of a set of received video frames captured by the wide-angle lens of the video camera 10. The video signal processor 61 can process video data by encoding and/or decoding into various video formats. The data storage device 62 allows the user to permanently and/or temporarily store data of any format (video, audio, photo, and other formats). The data storage device 62 can carry out various data processing operations (copying, deleting, recording, etc.) from a connected wireless device and/or through an interface cable to an external user device (computer, smartphone, tablet). The module for converting/supplying electrical power 63 can receive electrical energy supplied through the interface cable from the electrical network of the room in which the present invention is located. The power conversion/supply module 63 can convert incoming electrical energy and transmit it to devices and various components located on boards 28a-28b and 32a-32b of the video recorder 50. On board 32a, a memory module 64 can be located. This memory module 64 can store critical information about the factory settings of the video recorder 50. Generally, only the manufacturer can access this memory module. On board 32b, a data transfer device 65 may be located. In this embodiment, the wireless communication module may allow connection to a video recorder 50 via Wi-Fi and Bluetooth technologies. The shape and/or number and/or arrangement of the devices shown may vary depending on the design or application of the invention.

### Magnetic Support Arrangement

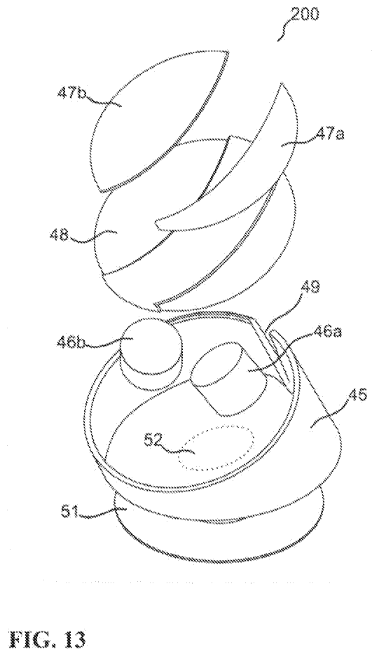

FIG. 13 is an enlarged view of a magnetic support 200 of one embodiment of the present invention. The depicted example of a magnetic support 200 may be composed of a support holder 45, a spherical platform 48, magnets 46a-46b. The support holder 45 can be made of aluminum, various types of plastics and/or other similar metals, and/or have various shapes and/or sizes. In the embodiment shown, the support holder 45 is made of aluminum. The support holder 45 can accommodate a center hole 52 for easy connection to the wall bracket 54. The holder can contain magnets 46a-46b, which are used in the invention to implement a mechanism for fixing the video recorder 50 in the magnetic support 200 and/or fixing the magnetic support 200 itself on metal and other surfaces with magnetic properties. The support holder 45 may include a cable slot 49 for a cable entry of the video recorder 50, while the cable slot 49 can be configured for various types of cables. In this FIG. 13, cable slot 49 can be used for a USB-C cable. The cable can be used to supply power and/or transfer/exchange data (audio signals, video signals, control commands, etc.) between the external user device 202 and the video recorder 50. The magnets 46a-46b are located in the support holder 45 in such a way that an optimal distribution of the magnetic field occurs which provides the maximum attractive force of the video recorder 50 to the magnetic support 200 and/or the magnetic support 200 to the mounting surface. The magnets 46a-46b can be permanent magnets or electromagnets and/or a combination thereof. The shape, arrangement and/or number of magnets may vary depending on the design and/or application of the present invention. The support holder 45 may contain the logo and the name of the manufacturer and/or the name of the model of the invention. In FIG. 13, a spherical platform 48 is located in the support holder 45, which serves as a base support surface for the outer spherical surface of the video recorder 50. The diameter of the sphere of the platform 48 and the sphere of the case of the video recorder 50 are equal or differ slightly (up to 0.5 mm). Due to the spherical shape of the contact surfaces, a smooth, convenient and accessible change of the position of the camera for the consumer is provided in a wide range of tilt angles in the horizontal and vertical planes. The spherical shape of the contact surfaces also provides maximum simplicity and speed of docking (connection, articulation) of the video recorder 50 and the magnetic support 200 in any relative position. In FIG. 13, thin spacers 47a-47b are located on the spherical platform 48, repeating the contour of the sphere of the platform 48. The spacers 47a-47b and the platform 48 can be made as a single product. In the illustrated example, the spacers 47a-47b are made of a thermoplastic elastomer. As a result of the asymmetric arrangement of the metal mounting beams in the upper 20 and lower 14 hemispheres of the housing, a situation of inaccurate setting of the desired position of the video recorder 50 in the magnetic support 200 may arise. The purpose of the spacers 47a-47b is to provide the necessary and sufficient frictional force between the outer spherical surface of the video recorder 50 and a magnetic stand 200 to prevent video recorder 50 rotation at all angles of installation. At the same time, the spacers 47a-47b should exclude (as in the above example) friction of the metal surfaces of the video recorder 50 and magnetic support 200 against each other, which could lead to damage to the decorative-protective coating of the products and result in loss of the outlook of the present invention. The material, shape and/or number and/or thickness of spacers 47a-47b may vary depending on the purpose and design of the present invention. To avoid sliding on a horizontal surface, a thin disc spacer 51 with an increased coefficient of friction can be used. The shape and/or quantity and/or material of the disc spacer 51 may vary depending on the design and application of the present invention.

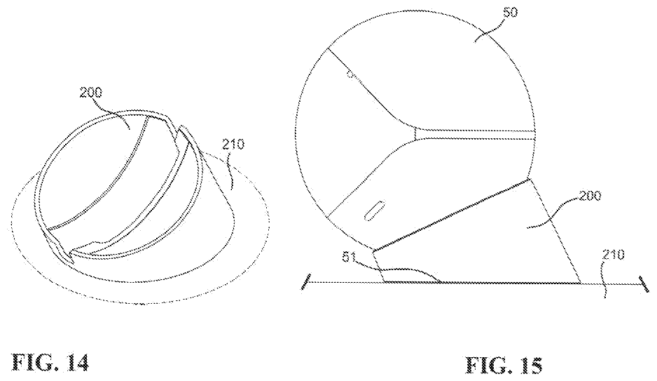

FIG. 14 shows an example of the installation of the magnetic support 200 on a horizontal surface 210.

FIG. 15 shows a side view of a magnetic support 200 which is mounted on a horizontal surface 210 with the video recorder 50 placed in the magnetic support 200. The magnetic support 200 can be placed on any horizontal surface 210. For example, it can be a working surface of a writing desk, a section of a table near a computer, a shelf on the wall, the top surface of a cabinet, a refrigerator, etc. The disc spacer 51 with an increased coefficient of friction is installed in a magnetic support 200 and excludes longitudinal displacements along the surface of the support 200 together with the video recorder 50. The disc spacer is a rubber disc glued to the bottom of the magnetic support to make it less slippery. In this configuration, the video recorder 50 in the magnetic stand 200 can be oriented as desired, subject to the camera lens 10 field of view.

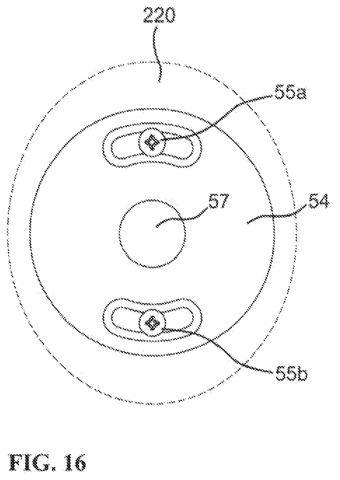

FIG. 16 shows an example of wall bracket 54 on a vertical surface 220.

FIG. 17 is a side view showing the wall bracket 54 mounted on a vertical surface 220 gives an idea of how the magnetic support 200 and with it, the video recorder 50, can be placed on vertical surfaces 220 for various applications. This option is suitable for cases where the wall materials are not magnetic and/or non-metallic. For example, it can be walls of residential and commercial premises which are made of wood, concrete, plastic and other non-metallic materials that do not have magnetic properties. The bracket 54 is made of magnetically sensitive steel, which has magnetic properties, which allows the support 200 to be attached to it due to the magnets 46a-46b (which are shown in FIG. 13), without additional fixtures and/or fasteners (e.g. screws, adhesive tape, glue, etc.). The bracket 54 can be attached to vertical surface 220 using screws 55a-55b or adhesive tape. The bracket may be provided with a centering protrusion 57, which fits into the centering hole 52 of the magnetic support 200. This provides a convenient and unambiguous connection between the magnetic support 200 and the bracket 54 to the wall. In addition, this connection element eliminates the possibility of longitudinal displacement of the support 200 relative to the bracket 54, which could cause the video recorder 50 to fall or topple over.

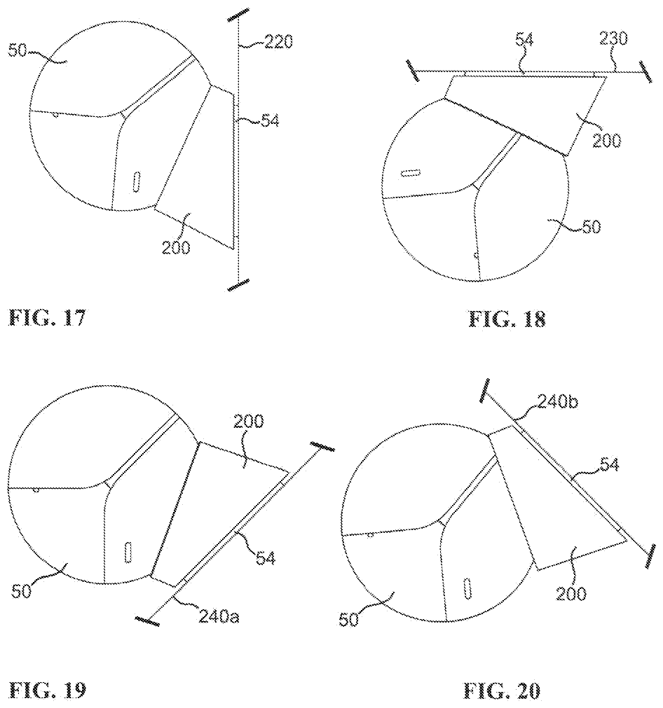

FIGS. 17-18 show examples of attaching a wall bracket 54, magnetic support 200 and one of the options of video recorder 50 to vertical 220 (e.g. room wall) and horizontal 230 (e.g. room ceiling) surfaces.

FIGS. 19-20 show various means of attaching a wall bracket 54, a magnetic support 200 and a video recorder 50 to inclined surfaces (e.g. a wall of a room with a slope or a furniture shelf 240a or an inclined surface of a wall of an attic room 240b).

For cases where the installation of the video recorder 50 with the support 200 is required on vertical, horizontal, inclined and sheer surfaces made of materials with magnetic properties (e.g. a metal refrigerator door or garage door), the wall bracket 54 is not required. The magnetic support 200 can be attached directly to the surface due to the magnets 46a-46b that are disposed therein.

In all of the above placement configurations, the exact orientation of the video recorder 50 may be different with respect to the horizontal and vertical axes of the device. The video recorder 50 can be positioned in the support 200 upside down, and the video frame would not be flipped thanks to the built-in three-axis accelerometer 27, the software module can set the reverse flip of the recorded video signal.

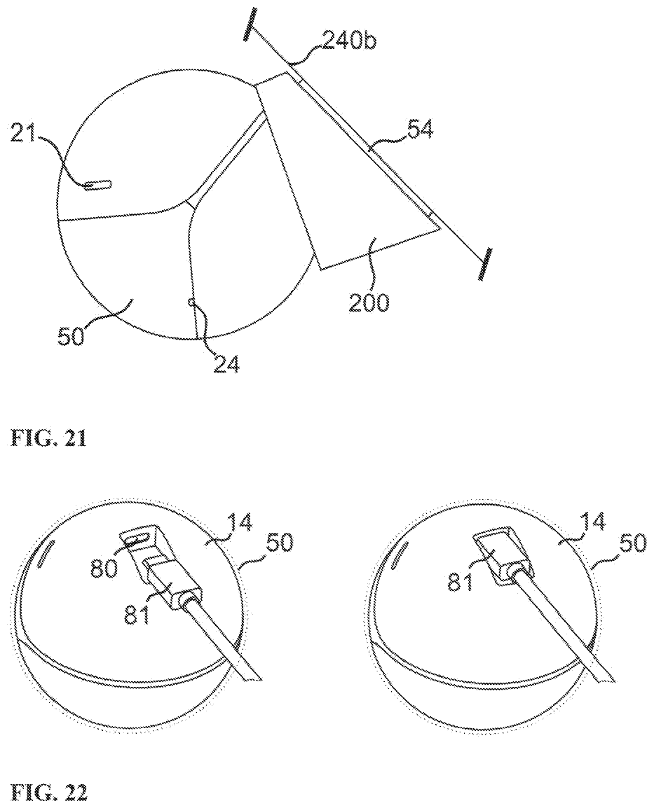

FIG. 21 shows an example of placing the video recorder 50 upside down. In the shown view, the speaker openings 21 are located above the microphone openings 24. In this situation, the video recorder 50 is deployed around its horizontal axis by 180 degrees.

FIG. 22 shows an example of connecting the power cable 81 to the matching camera cable connector 80 of the video recorder 50. In this example, an option with the USB-C cable and connector is shown.

### Power Supply Variations

Power can be supplied to the video recorder 50 by using a CAB.68.003 cable with a length of up to 30 m for the PoE option (power over ethernet) and up to 20 m for the USBC option, as well as data transfer between the Wi-Fi+LTE camera using High Speed USB-C specification circuits. The specified parameters are achieved when the camera is connected to the power adapter of one of the options:
Camera option WiFi-LTE-PoE must use Adapter with PoE, a cable can be used CAB.68.003 or CAB.68.004 up to 30 m.
Camera option WiFi-LTE-USBC must use Adapter with USB-C, cable can be used CAB.68.003 up to 20 m.

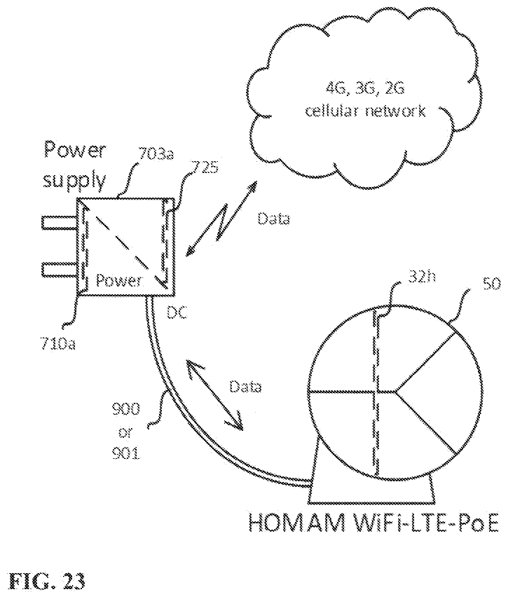

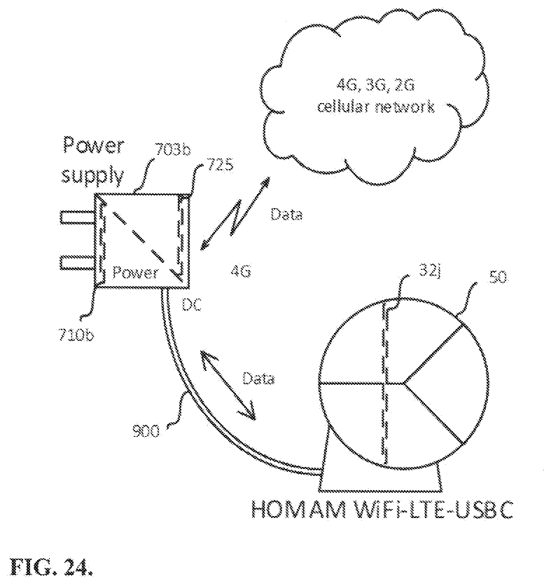

The general structure of the WiFi-LTE-PoE power supply option is shown on FIG. 23 and WiFi-LTE-USBC power supply option is shown on FIG. 24. For all versions of the power adapter, the LTE module remains the same. Power adapters of any design can be connected to any device containing a USB-C connector. A standard USB-C to USB-C cable may be used with a restriction that if there is a High Speed USB-C circuit in the cable, according to specification, due to the lack of Smart switch, the length of such cables can be no more than 2 m.

The following sections describe power supply adapters separately including the version with a PoE power supply option and a version with a USB PD power supply option.

Adapter with PoE Option

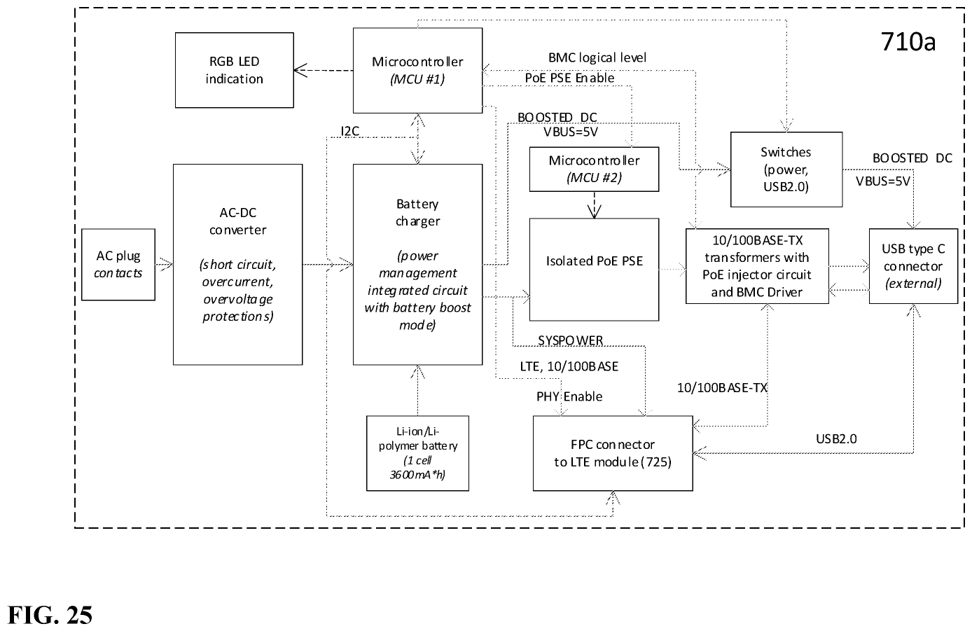

The structural diagram of the power supply with PoE option is shown on FIG. 25. Referring to FIG. 23 and FIG. 25, the power supply unit includes two composite nodes: a Power supplier and a LTE wireless transceiver. These nodes are located on separate printed circuit boards: a Power Board and a LTE module Board. The connection is made via FPC connectors by FFC cable. The AC adapter is implemented with Battery backup and PoE injector circuit.

The power board is equipped with two controllers.

### State Machine:

MCU #1 enable flow for MCU #2. Wait for results.
MCU #2 enables low-voltage power to the remote load via the twisted pair phantom circuits (using the midpoints of the transformers) and polls the remote controller through the BMC driver. If the Manufacturer_Info and Security_Response responses match (the protocol is inherited from the standard to the specified masks, the MCU #2 controller initiates the standard IEEE 802.3af-2003 PoE procedure, after which it receives confirmation from the remote controller that the power is correct (set of parameters).

Depending on the results of the PoE initialization procedure, MCU #1 either switches to monitoring the PoE power status or initiates the supply of standard VBUS=5V.

Referring to FIG. 25, the adapter is universal for AC networks with voltage from 85 V to 305 V and frequency from 47 Hz to 63 Hz. The AC to DC converter provides a constant output voltage of 5 V and a constant output current of at least 2 A. The AC adapter includes protective electronic components against short circuit, overload and overvoltage. An AC-DC converter is necessary to provide DC power for external devices connected to the USB type C connector and for system operation.

From the converter output, direct current is supplied to the charger input of the one-cell Li-ion or Li-polymer battery. The battery is necessary for the LTE modem to operate at high pulse loads by increasing the output current and as a backup power source. The charger contains built-in transistors that ensure that the battery is disconnected from the system during abnormal modes of operation (such as overheating), protection against reverse polarity voltage and switching for a pulse converter in battery boost mode. The charger uses a thermistor (NTC) to control battery temperature.

The parameters of the charger operating modes are configured using microcontroller MCU #1 via the I2C bus. In particular, it is possible to change the charge currents and threshold voltages for different stages of the battery charge (after deep discharge, direct current, constant voltage). MCU #1 allows indication of the states and operating modes of the AC adapter using RGB LED, control of switch integrated circuits for USB2.0 data lines (selection of the required pair according to the connected side) and output voltage, external load detection and determination of the cable side.

The USB type C connector is used to connect an external device to the power supply, as well for receive and transmit from/to external device data using the LTE transceiver. Only USB2.0 lines, one pair of symmetrical high-speed USB3.0 lines as Ethernet 10/100 Mb lines, Configuration Channel (CC) lines and power lines are used in the connector. All lines are provided with surge protection (electrostatic discharge). Ethernet lines also include self-resetting fuses.

Ethernet lines support Power over Ethernet (PoE) technology, which allows the transmission of electrical energy to the consumer through pairs of signal lines (PSE, power sourcing equipment). The increased voltage for PoE organization is obtained by means of an isolated flyback converter based on a pulse multi-winding transformer and n-channel MOSFET. The output voltage is regulated by changing the duration of the current pulses in the primary winding. The feedback loop uses a pulse width modulation (PWM) controller to switch the transistor. The controller has leads to compensate for the control loop and change the switching frequency. The MCU1 pin, which controls the glow of the green component of the RGB LED, can also change the switching frequency of the flyback transistor by means of a modulating signal (carrier frequency envelope).

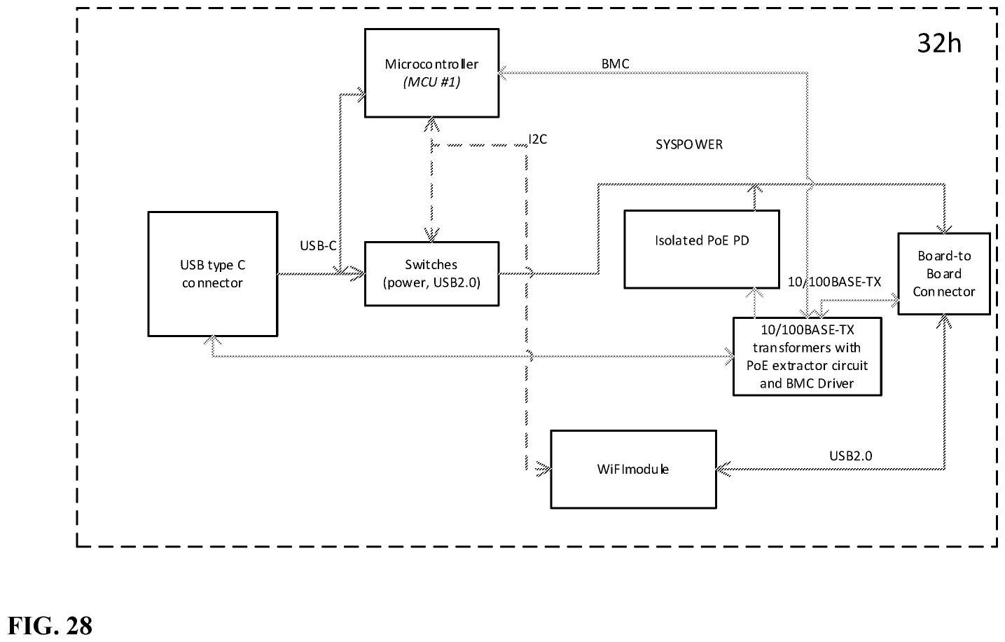

FIG. 28 shows the block diagram of the module that allows the video recorder 50 to be powered via a PoE.

Adapter with USBC Option

The structural diagram of the power supply with PoE option is shown on FIG. 23.

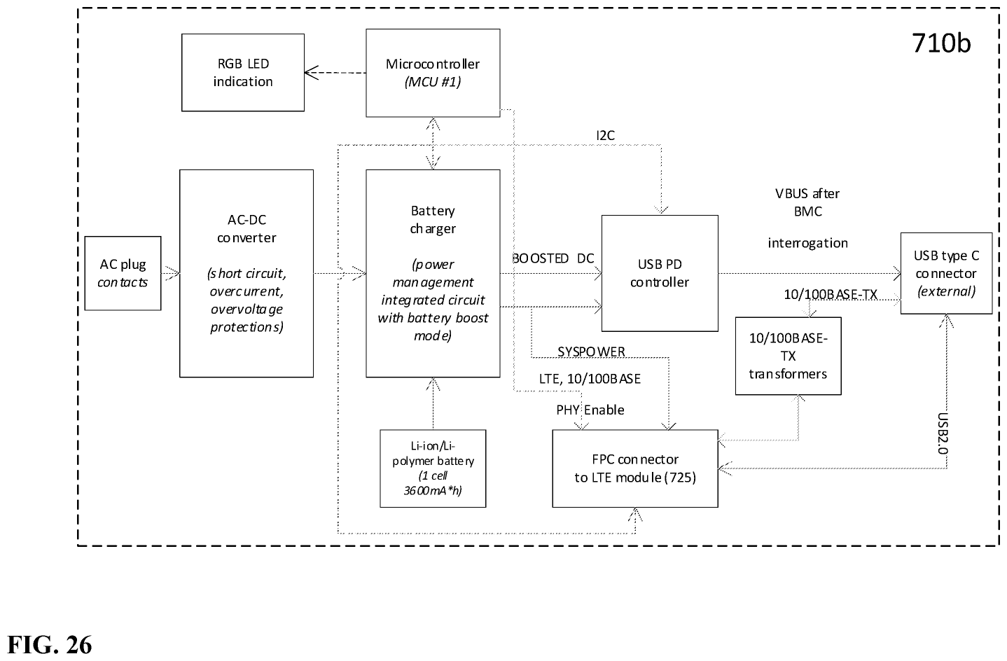

Referring to FIG. 24 and FIG. 26, the power supply unit includes two composite nodes: a Power supplier and a LTE wireless transceiver. These nodes are located on separate printed circuit boards: Power Board and LTE module Board. The connection is made via FPC connectors by FFC cable. The AC adapter is implemented with Battery backup and USB PD function.

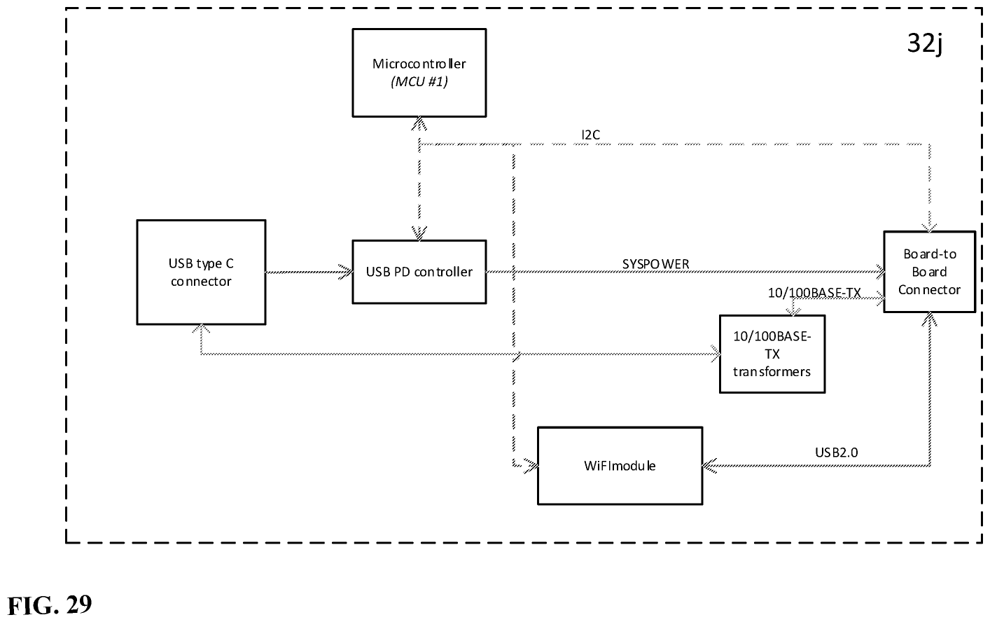

The block diagram of the module that allows the video recorder 50 to be powered via USB PD is shown in FIG. 29. The booster is initially set to 5V. Next, the standard USB PD procedure is initiated by detecting the current capacity, the booster mode is set (but not more than 9V in accordance with the maximum power of the AC-DC converter). If the capacity supports the BMC protocol, an additional poll is made for Manufacturer_Info and Security_Response. If the Manufacturer_Info and Security_Response responses (the protocol is inherited from the standard) match the specified masks, the booster is set to 15V, which allows one to supply power to the WiFi-LTE-USBC camera using the CAB.68.003 20 m cable (the length is limited to a greater extent by the possibilities to provide a standard AWG 32 wire BMC protocol).

### LTE Module.

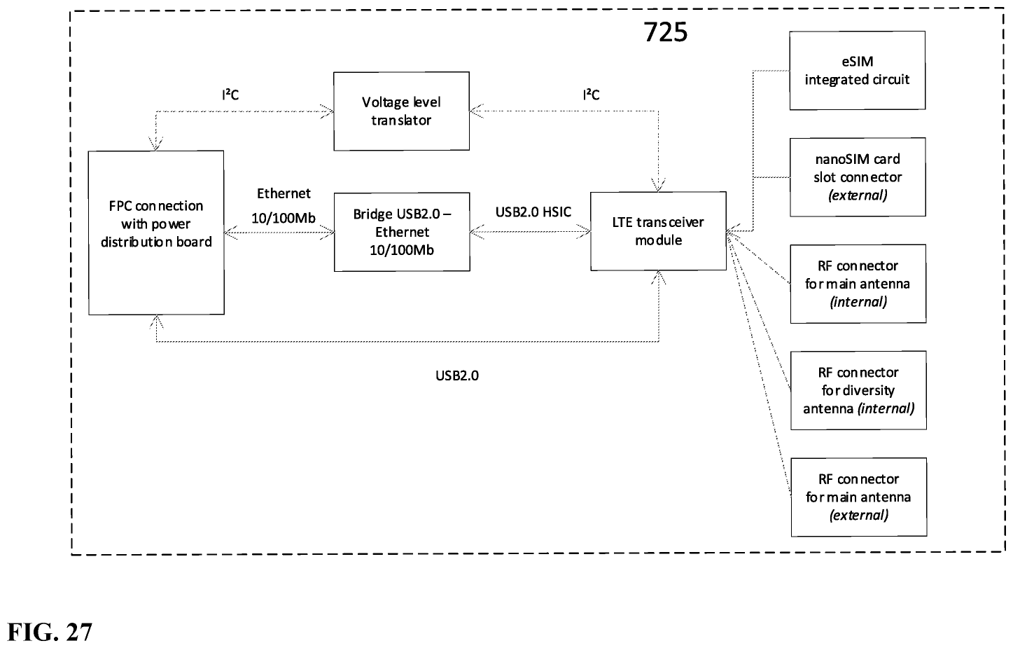

The LTE transceiver board (FIG. 27) includes a LTE module for receiving and transmitting data via a cellular network, an interface converter (bridge) of the USB2.0 type—10/100 Base TX, a down-pulse voltage converter to provide power to the bridge, a slot-connector for connecting a physical SIM card of the nanoSIM type, an eSIM type virtual SIM card as an alternative, a logic level converter for matching the I2C bus of the LTE module and the MCU1 microcontroller and high-frequency connectors for connecting internal and external antennae. The physical interface 10/100 Base TX turns on only after detecting a remote capacity like a WiFi-LTE-USBC or WiFi-LTE-POE camera.

### Cable Variants

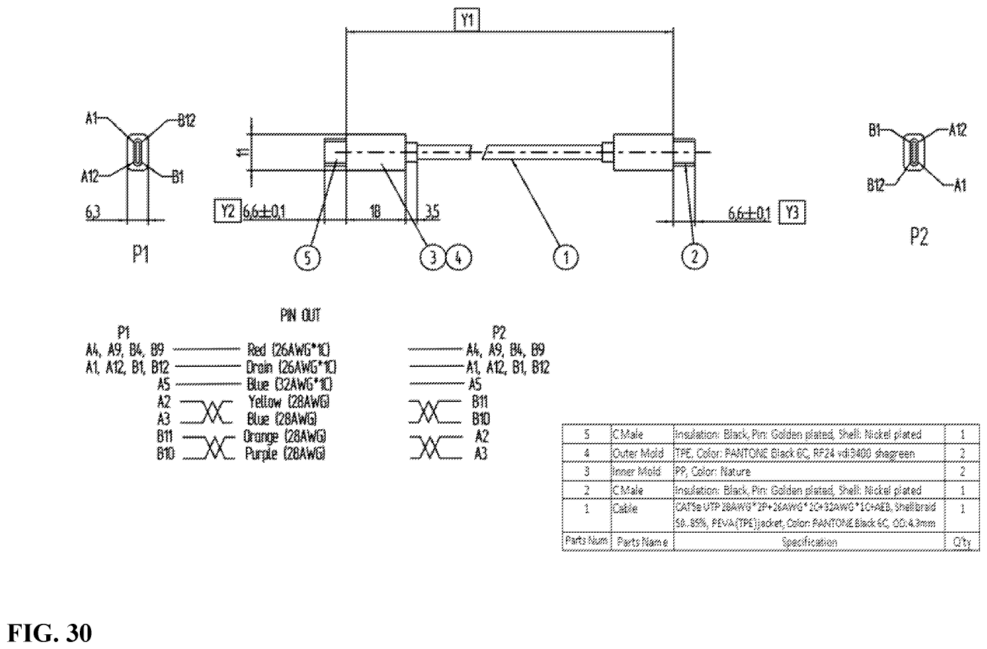

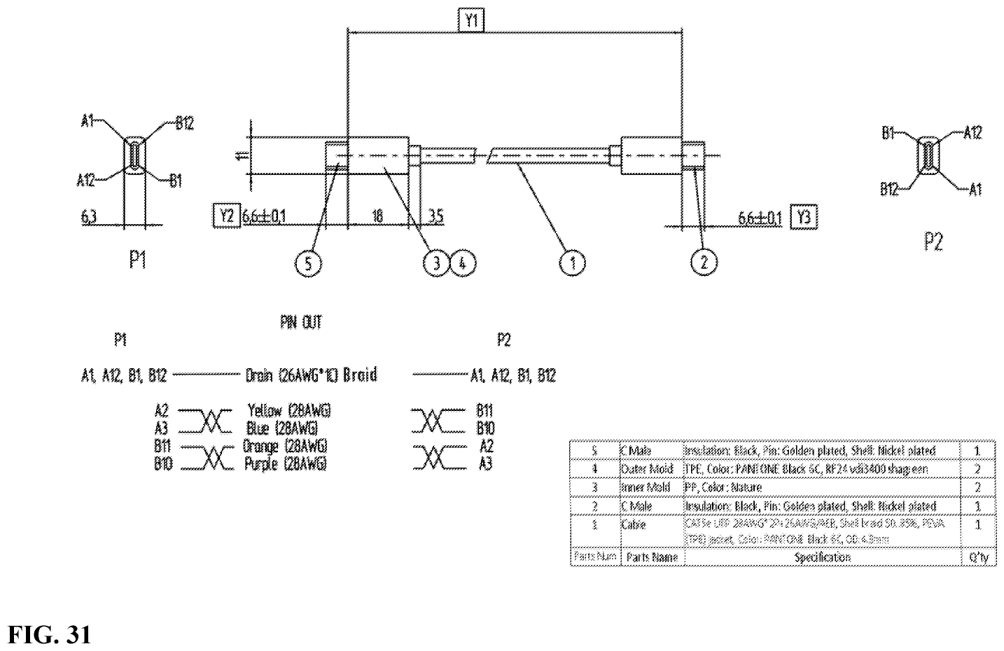

Cables CAB.68.003 specification is given on FIG. 30 and CAB.68.004 on FIG. 31.

For PoE power supply option two different cable types can be used:
CAB.68.003 up to 30 m;
CAB.68.004 up to 30 m;
   For USBC option only CAB.68.003 up to 20 m can be used.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A video surveillance and data transmission system comprising:
a. a video camera with a wide field of view camera lens, a video camera module, and a processing, storage and/or data transmission unit housed in a spherical camera body;
b. a support for the system with a magnetic holder capable of allowing the camera to be oriented and fixed at any position within 360 degrees around the vertical axis and within 180 degrees around the horizontal axis, and a support attachment bracket that allows the camera to be on any vertical wall or surface, any horizontal surface, or any tilted/angled surface;
c. a power supply unit connected to the video camera with a cable providing necessary power to the video camera.

2. The video surveillance and data transmission system of claim 1, wherein the video camera lens is positioned behind a semi-transparent tinted glass, wherein said glass is a part of the camera lens optical scheme and is semi-transparent in visible light region, resulting in the video surveillance system being inconspicuous and not readily identifiable as a video recording and transmission device.

3. The video surveillance and data transmission system of claim 2, wherein at least one illumination source for video recording in low or insufficient room light conditions is placed behind the tinted glass.

4. The video surveillance and data transmission system of claim 3, wherein said illumination source is a set of between four and twelve infra-red LEDs placed in a specific configuration that allows all the objects that are in the video recorder field of view to be fully illuminated, said configuration further ensuring that the infrared diode light flux is not internally reflected to the camera lens.

5. The video surveillance and data transmission system of claim 4, wherein the intensity of individual infrared LEDs can be adjusted to equalize scene illumination in darkness or low light conditions.

6. The video surveillance and data transmission system of claim 4, further comprising specially configured and positioned infrared diode holders directing the direction of infrared light flux thereby stopping marginal infrared beams from illuminating objects outside of camera field of view.

7. The video surveillance and data transmission system of claim 1, further comprising a camera spherical housing with specific microphone openings with at least two stereo microphones installed, allowing the recording stereo audio simultaneously with video recording, wherein bracket shape and cavity volume are specially calculated and designed to obtain high quality surround sound.

8. The video surveillance and data transmission system of claim 7, wherein a three-axis accelerometer is installed to facilitate rotating and rectifying the recorded video image and change microphone channels in order for the video image to appear right side up and the associated sound correspond to the upright image.

9. The video surveillance and data transmission system of claim 1, wherein the camera spherical housing has one or more speaker openings, each such opening having a stereo loudspeaker enabling the playing of audio from the video recorder.

10. The video surveillance and data transmission system of claim 9, wherein the spherical camera housing is made of metal and Wi-Fi antennas are placed behind the plastic cover glass such that there is no shielding or weakening of the transferred or incoming Wi-Fi signal.

11. The video surveillance and data transmission system of claim 1, wherein the power supply has an internal LTE modem cable with data transfer capability connecting the video recorder and power supply.

12. The video surveillance and data transmission system of claim 11, wherein the power supply supports a Power over Ethernet power supply option and data cable lengths up to 30 meters.

13. The video surveillance and data transmission system of claim 11, wherein the power supply supports USB type C connections and specifications.

14. The power supply of claim 13 wherein special cable variant CAB.68.003 supports both USB type C and PoE power supply options and simultaneous data transfer.

15. The power supply of claim 13 wherein special cable variant CAB.68.004 supports only the PoE power supply option and simultaneous data transfer with fewer wires than the CAB.68.003 cable variant.
